(19) United States
(12) Patent Application Publication
(10) Pub. No.: US 2003/0059283 A1
(43) Pub. Date: Mar. 27, 2003

(54) Handling device

(76) Inventor: Helmut F. Jager, Konigsbach-Stein (DE)

Correspondence Address: Henneman & Saunders, 714 W. Michigan Ave., Three Rivers, MI, 49093, US

(21) Appl. No.: 10/229,947

(22) Filed: Aug. 28, 2002

(30) Foreign Application Priority Data
Aug. 31, 2001 (DE) 101 44 248.3-22

(51) Int. Cl. B65G 1/00

(52) U.S. Cl. 414/331.01

(57) ABSTRACT

A handling device for handling of parts is disclosed. The handling device comprises a storage module within which a plurality of support locations are provided in a stacked way for supporting pallets on different levels. The handling device further comprises a presentation module for handling and presentation of parts being linked for transferring parts with at least one station assigned thereto. Further, a transport device for moving pallets between the lifting module, the storage module and the presentation module is provided.

### FOREIGN PRIORITY

This application claims the right of foreign priority to Application No. 101 44 248.3-22 filed in Germany on Aug. 31, 2001, which is incorporated herein by reference in its entirety.

### BACKGROUND OF THE INVENTION

The invention relates to a handling device for handling, storing and transferring parts which are received on pallets, the apparatus being linkable with another station of a manufacturing system, for instance for supplying a machine tool with unmachined parts and for removing machined parts therefrom.

Such handling devices have been known for a long time and are utilized in manufacturing systems for facilitating the part-flow to the processing stations cooperating therewith. In particular, the handling devices are used in manufacturing systems for buffering parts to decouple the different stations of a system. In such a handling device known from EP-A-0 865 869, individual pallets are passed by means of a stack exchange module with a rotating plate into a handling room which is closed to the outside and within which the pallets can be received by means of a further operational module, can be restacked and prepared for transfer to a gantry cooperating therewith.

According to a further handling device known from DE-A-198 05 206, stacked pallets which are received on trolleys are transferred by means of a stack transport device between a feeding position, a removing position and a presentation position, wherein a gantry is provided for picking up parts by means of a gantry gripper from a pallet or for placing same thereon.

Although both prior handling devices have particular advantages for handling parts received on pallets, there are, however, particular drawbacks which relate to the fact that the pallets on which the parts are received are consolidated to pallet stacks, whereby additional transport operations, restacking operations or the like may become necessary. When handling volume parts, i.e. parts that have a considerable volume, further problems arise from the large space required. Since the lifting height of such a handling device is limited, such handling devices can support only very limited numbers of parts, whereby the buffering capacity of the respective handling device is very limited. If the buffering capacity shall be increased, this leads to a respective increase of the floor space required by the respective handling device.

Also belts that are frequently used in manufacturing systems for transporting and buffering parts have considerable drawbacks, since also belts have only a limited buffering capacity and are not suitable for a fast part-flow or for tracking individual parts throughout the manufacturing system.

From WO 97/37564 a mechanical storage device comprising a lifting station, a storage station for receiving pallets and further comprising an output station, is known.

However, such a device is not suitable for integration into a manufacturing system. By contrast, the storage device disclosed is merely designed for manually inputting parts into the storage device and for manually retrieving parts from the storage device.

### SUMMARY OF THE INVENTION

It is a first object of the invention to provide a handling device avoiding the drawbacks of the prior art.

It is a further object of the invention to provide a handling device having an improved buffering capacity for buffering parts, even when floor space is limited.

It is a further object of the invention to provide a handling device allowing a fast and flexible access to individual parts or pallets.

It is a further object of the invention to provide a handling device that is particularly suited for the handling, storage and buffering of large parts.

These and other objects of the invention are achieved by a handling device for handling and presenting parts, comprising a lifting module for lifting and lowering of pallets, a storage module within which a plurality of stacked storage places for receiving pallets are provided at different levels, further comprising a presentation module for handling and presenting parts being designed for linking with at least one station for transferring parts being assigned thereto, and further comprising transport means for moving pallets between the lifting module, the storage module and the presentation module.

According to the invention, a storage module in the form of a vertical storage is utilized which can be used for inserting or removing, respectively, pallets onto particular support locations or from particular support locations, respectively, and for transferring to a presentation module. The handling device may be operated fully automatically, semi-automatically or, in certain aspects, manually.

According to the invention the buffering capacity is particularly increased while keeping the required floor space constant by simply increasing the design height of the storage module. Since normally in manufacturing systems, only the necessary floor space shall be kept as small as possible, while frequently the available height has not been utilized completely, such a handling system leads to a considerably increased capacity for receiving parts which, in particular, is important with respect to volume parts.

In a manufacturing system according to the invention, a handling device according to the invention is linked to at least one station for performing processing, transport and/or handling operations on parts.

The handling device according to the invention allows for a selective access to individual pallets without requiring prior restacking operations. This leads to the advantage that different manufacturing strategies can be performed in a linked manufacturing system simply program-controlled. Thus a manufacturing system which is interlinked by means of handling devices according to the invention and by means of gantries assigned thereto, guarantees a flexible part-flow, while a good break-down safety of the total system is reached. Herein, the respective strategy can be changed without any problem, e.g. from “first in/first out” to “one-piece-flow” or to keeping a particular minimum number of parts stored in a handling device, or to the “refreshing” of a buffer, i.e. an emptying of all parts received in a handling device, before fresh parts are stored again etc.

In addition, it is possible to access individual parts or pallets without any time lag. For instance, thus particular parts may be checked selectively, may be inserted or withdrawn.

An additional advantage of the handling device according to the invention results from the fact that different types can be stored, whereby different types can be processed and stored or intermittently stored, respectively, during an ongoing manufacturing process without any problems.

Highly efficient logistics software can be utilized for control. In total, an organic, modular control concept can be reached for the overall manufacturing system.

It is conceivable to store additional parts in the handling device, which normally must be input or output externally. In this way, for instance, exchange parts for machines may be stored, as well as adapters, clamping adapters, tools etc. which may be used for manual, automatic or partially automatic feeding of processing devices or other stations.

Depending on the particular needs, the handling device according to the invention may be designed modular or may be extended by individual stations.

Thus a handling device according to the invention in its simplest form may merely comprise a storage module, a lifting module and a presentation module, so as to supply one or more processing stations, e.g. machine tools, with unmachined parts and for removing machined parts therefrom. However, such a handling device may also be a part of an interlinked manufacturing system and may not only perform storage and handling operations, but also additional functions which may include for instance a presentation module comprising a device for performing additional operations, such as a cleaning device, a positioning device, a pivoting device for pivoting parts about one or more axes, a blowing device, a washing device, a marking device or an examining device for examining parts.

An additional advantage of the invention rests in the fact that the parts are protected within the storage module against environmental influences and against interaction from the outside.

According to a further embodiment of the invention, the lifting module is linked with at least two storage modules.

Thereby, the buffer capacity of the handling device is increased in a relatively cost-efficient way.

According to a further embodiment of the invention, the handling device comprises a storage module for loading and unloading parts or pallets.

Thereby, an operator may input parts or pallets into the handling device or may output same therefrom. Herein also particular parts which for instance must be checked, can first be stored on a pallet and can be output thereafter. In addition, also parts which e.g. were found to be defective (“NIO parts”) may be output separately. The loading module may be arranged at a level which is optimal under ergonomic considerations, such as at a height of 900 mm, while the presentation module may be arranged at a different height, for instance at 1400 mm, which is optimal for a machining station, such as a machine tool, linked therewith.

It is suitable to provide the loading module for loading and unloading with a protection against interaction with the remaining parts of the handling device so as to provide accident protection. To this end, for instance between the loading module and an adjacent storage module, a gate may be provided.

According to an additional preferred embodiment of the invention, the presentation module comprises a gantry whereon a gripper for handling parts is received displaceably.

Depending on the particular needs, the gripper may simply be displaceable along the gantry or may allow a pick-up or a placing of parts or a pivoting of parts about one or more axes and may possibly also allow a linear movement or a pivot movement by means of a rocker.

As mentioned above, the presentation module may comprise additional devices for performing additional operations.

Also the presentation module may comprise a receiving trough for collecting liquids, e.g. to allow a washing operation in combination with a cleaning axis.

According to an additional embodiment of the invention, the transport means for moving pallets between the lifting module, the storage module and the presentation module may comprise a towing drive upon which at least one driver is provided cooperating with driver supports on the pallets.

Thereby, a particularly simple, reliable and cost-effective transport of pallets between adjacent stations of the handling device is made possible.

The lifting module may comprise a pallet support being guided vertically displaceably. On a front surface of the pallet support an endless conveyer element carrying a plurality of drivers may be received, the drivers engaging with driver sup-ports on the pallets, so as to allow moving a pallet in horizontal direction between the lifting module and at least one adjacent station.

According to a further embodiment of the invention, the lifting module comprises a pallet support being guided vertically displaceably and being linked to a linear drive for vertically displacing the pallet support.

In this way, a fast and precise positioning of pallets between the individual storage positions in vertical direction, and by means of the towing drive, a selective movement in horizontal direction is made possible.

If additional adjacent stations are provided which cannot be reached by means of the towing drive of the pallet support of the lifting module, then additional stations may be linked with additional conveyer devices designed as linear drives, towing drives or other drives, to guarantee a movement of the pallets between the additional stations.

According to an advantageous development of the invention, the handling device comprises at least one numerically controlled drive. This may be a drive for the lifting module for lifting and lowering and/or may be a drive for horizontally moving pallets between the lifting module, the storage module, the presentation module or other stations. The numerically controlled drives may be freely programmable.

Thereby, a fast transport and a precise positioning of pallets or parts, respectively, is made possible.

According to a further embodiment of the invention, at least in the region of the presentation module, stop elements are arranged which cooperate with a transport means for positioning pallets.

Thereby, in a simple way, a precise positioning of one pallet each is made possible in a region where handling processes are performed.

### BRIEF DESCRIPTION OF THE DRAWINGS

It will be understood that the above-mentioned and following features of the invention are not limited to the given combination, but are applicable in other combinations or taken alone without departing from the scope of the invention. Further features and advantages of the invention will become apparent from the following description of preferred embodiments taken in conjunction with the drawings. In the drawings show:

FIG. 1 a perspective view of a first embodiment of handling device according to the invention, in simplified representation; and

FIG. 2a top view of a further embodiment of a handling device according to the invention which comprises a processing station linked therewith, in schematic representation.

### DETAILED DESCRIPTION OF THE PREFERRED EMBODIMENTS

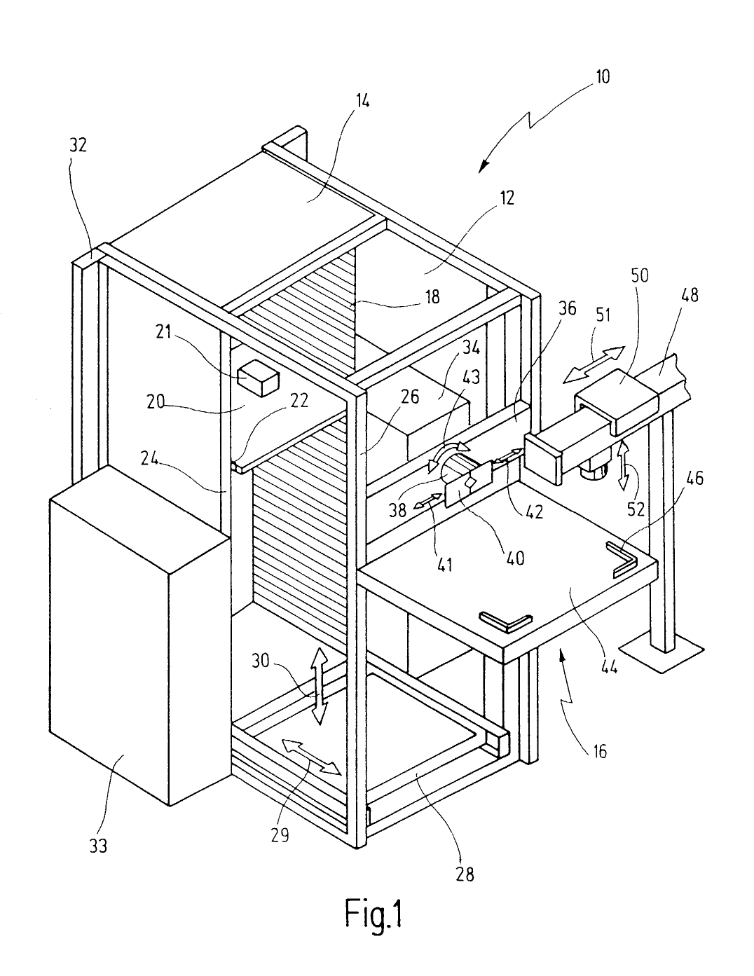

In FIG. 1, a handling device according to the invention is designated in total with numeral 10.

The handling device 10 comprises several modules which all are supported on a rigid frame 32, so that the handling device 10 may be transported in total and may be placed at a selected location within a manufacturing system. The handling device 10 comprises three modules, namely a storage module 14 within which a plurality of storage places 18 for receiving pallets 20 are vertically stacked, further a lifting module 12 comprising a pallet support 28, and further comprises a presentation module 16 which is adjacent to the lifting module 12.

Within lifting module 12, the pallet support 28 is guided in vertical direction along vertical guides 24 and is drivable in vertical direction not shown in detail, so that selected positions which are adjacent to particular support locations 18 of the storage module 14 may be accessed selectively, as indicated by arrow 30. In addition, the pallet support 28 also comprises some kind of a drive for displacing pallets 20 horizontally between the storage module on the one side, the lifting module 12 and the presentation module 16 on the other side, such as indicated by the double arrow 29.

The storage module 16 comprises a rigid table 44 which is mounted rigidly at a particular vertical position for receiving a pallet 20. On the table 44, stop elements 46 may be provided to precisely position a pallet 20 which may be displaced onto the table 44 for instance by means of the transport means of the pallet support 28 utilizing drivers which engage with driver supports 22 on the pallet 20.

In addition, on both sides of the storage module 14, control cabinets 33, 34 used for the necessary electric power supply and control, may be provided, such as shown in FIG. 1 for example.

The presentation module 16 is linked to an external station which allows to link the handling device 10 to additional stations of a manufacturing system. This may for instance be a gantry 48 upon which a gantry slider 50 supporting a gripper may be displaceable, thereby allowing a displacement of parts along the gantry in the direction of the double arrow 51 and, possibly, also in a direction perpendicular thereto, as indicated schematically by the double arrow 52.

In the simplest case, the presentation module only comprises a deposit possibility for supporting and transferring parts 21 between the external station, such as the gantry 48 and the handling device 10.

However, preferably additional operational modules are provided on the handling device, in particular in the region of the presentation module 16, for performing additional functions on parts 21. To this end, the presentation module 16 may for instance comprise a lateral gantry 36 on which a “cleaning axis” 38 is provided which allows a pivoting of parts about an axis such as indicated by the double arrow 43. Such a “cleaning axis” in combination with a washing device serves for washing (“cleaning”) parts in at least two different pivot locations. The cleaning axis 43 may support a gripper 40 which may have gripper elements displaceable with respect to each other, such as indicated by arrows 41, 42.

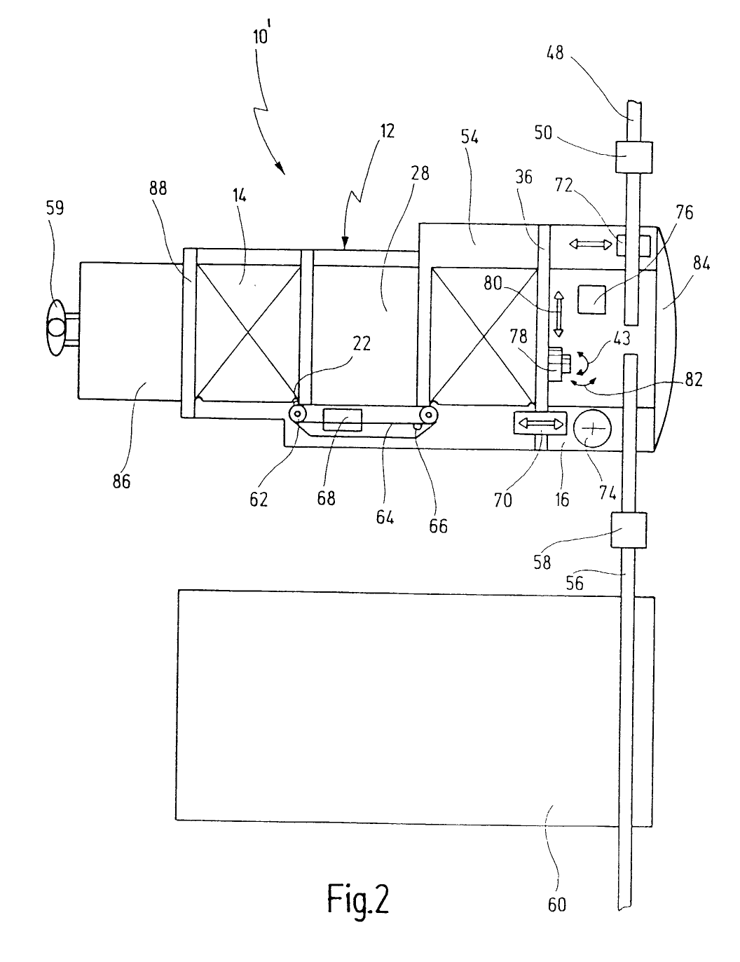

In addition, in the region of the presentation module 16, also additional modules may be supported to perform further operations on the parts, as will be explained hereinafter with reference to FIG. 2.

A modified embodiment of the handling device according to the invention is shown in FIG. 2 and denoted in total with numeral 10′.

Herein, for similar parts, the same reference numerals are utilized.

The handling device 10′ is part of a manufacturing system to which it may be linked for instance by means of a first gantry 48 and a second gantry 56. Both gantries end in the region of the presentation module 16 and comprise sliders 50, 58, by means of which parts can be displaced along the gantries 48, 56 and can be also be moved vertically, to thereby place parts 21 on a pallet located thereunder or for picking up parts therefrom.

In total, the handling device 10′ comprises five stations arranged consecutively. Corresponding to the design shown in FIG. 1, a storage module 14 is arranged directly adjacent the lifting module 12. However, by contrast to FIG. 1, on the other side of the lifting module 12, an additional storage module 54 is provided which is followed by the presentation module 16.

Finally, the storage module 14 is linked to a loading module 86 by means of a gate in a way protected against interaction, so that an operator 59 may remove parts from a pallet in the loading module 86 without any danger, or may place same therein, or may exchange complete pallets. When the gate 88 is open, the transport of a pallet 22 between the storage module 14 and the loading module 86 may be performed manually, for instance along rolls arranged thereunder or may be performed by a suitable drive.

While the loading module 86 is preferably located at the common height suitable for an operator 59, e.g. at 900 mm, the receiving position for pallets 20 within the presentation module 16 may be at a different level which for instance is suitable for processing stations linked therewith. Thus the receiving position might be at 1400 mm.

The handling station 10′ according to the invention allows such a combination without requiring any additional measures.

For transporting pallets 20 vertically between different support locations 18 of the storage modules 14 and 54, the lifting module 12 comprises a pallet support 28 which is controllably displaceable in vertical direction by means of a linear drive 68 (shown only schematically) which may for instance be designed as a toothed belt drive, to thereby access particular support locations 18 selectively. In addition, the pallet support 28 comprises a transport means by means of which pallets 20 are displaceable in horizontal direction between a support location 18 of storage module 14, the pallet support 28 and a support location assigned thereto at the adjacent storage module 54. To this end, each pallet 20 at its front face comprises two driver supports 22 each of which are located in the corner regions. On the pallet support 28 a towing drive 62 is provided which comprises an endless towing element 64 guided over two rolls or the like. The endless towing element comprises drivers 66 which can engage with driver supports 22 on the respective pallet 20. Thus, by means of this towing drive 62, a pallet can be moved in horizontal direction at the respective level, at which the pallet support 28 currently rests, between the storage module 14, the pallet support 28 and the storage module 54.

To allow for a transport of a pallet 20 between a storage module 54 and the adjacent presentation module 16, at the level of the presentation module 16 an additional drive 70 is provided (shown only schematically), which may also be a towing drive or which, for instance, may be a linear drive or a drive of a different kind.

Preferably, also this drive 70 is configured as a towing drive like the towing drive 62 and comprises drivers which already engage with the driver supports 22 of a pallet 20, before the end of the towing drive 62 is reached. Thus, a complete guidance up to the presentation module 16 is ensured.

Preferably, all the drives 62, 68, 70 are designed as numerically controlled, freely programmable drives.

At a machined outer surface of the storage module 54, a gantry 36 may be located at the side facing the presentation module 16. However, this may be deleted, or other transport and/or handling devices may be provided in the region of the presentation module 16.

In the case shown in FIG. 2, a slider 78 having a cleaning axis and an additional axis supported thereon, is displaceable along gantry 36, as indicated by double arrow 80. In addition, a pivoting about two axes is made possible, as indicated by the double arrows 43 and 82. Parts may be picked up or may be released by means of a gripper supported thereon.

In addition, in the region of the presentation module 16, for instance a slider 72 may be located allowing for a displacement of parts 21 between a position below the gantry 48 or the gantry 56, respectively, and a position below the slider 78 of the gantry 36.

In addition, for instance a rotating disk 74 may be located at a suitable position, by means of which parts may be pivoted by particular angles, e.g. by 90° or by 180°.

In addition, the presentation module 16 may comprise a collecting trough 84, so as to allow a washing process of parts. Further, additional devices which may be present in the region of the presentation module 16, are indicated schematically by numeral 76. This may for instance be a cleaning device, a positioning device, a pivoting device, a blowing device, a washing device, a marking device, an examining device etc.

The handling device 10 according to FIG. 1, or 10′ according to FIG. 2, respectively, may be linked with a manufacturing system in various ways. In FIG. 2, two gantries 48, 56 are indicated ending in the region of the presentation module 16. Therealong, sliders 50, 58 are displaceable which support gripping devices for transporting parts between the presentation module 16 and an additional station assigned thereto, such as a machining station 60. However, the handling device may also be linked to the manufacturing system in a different way, such as by means of a pivot device. A handling device according to the invention may be linked with one or more machining stations, such as machine tools, via a gantry to provide unmachined parts thereto and to remove machined parts therefrom. Also the handling device may be linked by suitable transport devices, such as gantries, with additional handling devices or with additional transport devices, storage devices etc.

It will be understood that the drawings are merely of exemplary nature, but not intended to limit the invention to the embodiments shown therein. By contrast, any person skilled in the art may easily design modifications thereof and further embodiments within the scope and spirit of the invention.

What is claimed is:

1. A handling device for handling and storing parts, said device comprising:
a lifting module for lifting and lowering pallets;
a storage module for storing pallets;
a plurality of vertically stacked storage places provided at different levels within said storage module for receiving pallets at said different levels;
a presentation module configured for supporting a pallet in a predefined position;
at least one gantry carrying at least one slider for transferring a part between a pallet being in said predefined position of said presentation module and at least one location external to said handling device; and
at least one towing drive carrying a plurality of drivers that engage with driver supports provided on the pallets, so as to allow moving pallets between said lifting module, said storage module and said presentation module in horizontal direction.

2. A handling device for handling and storing parts, said device comprising:
a lifting module for lifting and lowering pallets;
a storage module for storing pallets;
a plurality of vertically stacked storage places provided at different levels within said storage module for receiving pallets at said different levels;
a presentation module configured for supporting a pallet in a predefined position;
at least one transfer module being linked with said presentation module being configured for transferring a part between a pallet being in said predefined position of presentation module and at least one location external to said handling device; and
at least one drive linking said lifting module, said storage module and said presentation module for moving pallets therebetween.

3. The handling device of claim 2, wherein the lifting module is linked to at least two storage modules.

4. The handling device of claim 2, comprising a loading module for loading and unloading parts or pallets.

5. The handling device of claim 2, wherein the transfer module comprises a gantry.

6. The handling device of claim 5, wherein a gripper for gripping parts is displaceable along said gantry.

7. The handling device of claim 2, wherein said presentation module comprises at least one supplementary module for performing additional operations.

8. The handling device of claim 2, wherein said supplementary module comprises at least one of the group formed by a cleaning device, a positioning device, a pivoting device for pivoting parts, a blowing device, a washing device, a marking device and a examining device for examining parts.

9. The handling device of claim 2, wherein said presentation module comprises a receiving trough for collecting liquids.

10. The handling device of claim 5, wherein said gantry is configured for linking said presentation module with an external station.

11. The handling device of claim 10, wherein said external station is configured as a machining station.

12. The handling device of claim 10, wherein said external station is configured as a storage module.

13. The handling device of claim 2, wherein said drive comprises a towing drive which carries at least one driver that engages with driver supports provided on the pallets.

14. The handling device of claim 2, comprising at least one numerically controlled drive.

15. The handling device of claim 13, wherein said lifting module comprises a pallet support being guided vertically displaceably, said pallet support supporting an endless conveyor element of the towing drive, the endless conveyor element carrying a plurality of drivers configured for engaging with driver supports of a pallet, so as to allow moving a pallet in horizontal direction between said lifting module and at least one adjacent module.

16. The handling device of claim 2, wherein said lifting module comprises a pallet support being guided vertically displaceably, and wherein a linear drive is provided for vertically displacing the pallet support.

17. The handling device of claim 2, wherein the presentation module comprises a plurality of stop elements cooperating with said drive for positioning a pallet in said predefined position.
